(19) United States
(12) Patent Application Publication
(10) Pub. No.: US 2012/0061030 A1
(43) Pub. Date: Mar. 15, 2012

(54) CURTAIN AND METHOD OF HANGING A CURTAIN

(75) Inventor: Robert W. GIBBONS, Dorval (CA)

(73) Assignee: VERSAILLES HOME FASHIONS INC., Ville d'Anjou (CA)

(21) Appl. No.: 13/227,921

(22) Filed: Sep. 8, 2011

Related U.S. Application Data
(60) Provisional application No. 61/381,308, filed on Sep. 9, 2010.

(51) Int. Cl. A47H 23/04; B23P 17/04; A47H 13/02

(52) U.S. Cl. 160/84.01; 29/428

(57) ABSTRACT

The curtain includes a foldable panel having an upper edge and two opposite side edges. The foldable panel is reversibly moveable between an extended flat position and a fully folded position upon moving the opposite side edges relative to one another. The panel forms a plurality of juxtaposed sections separated by vertical pleats when the panel is folded. The curtain also includes a plurality of spaced-apart ribbons. Each ribbon has opposite ends connected to the upper edge of the panel and forms a loop. The ribbons extend above the upper edge of the panel when the curtain is hung under the horizontal pole. The curtain further includes a plurality of rigid connectors to be loosely inserted over the horizontal pole. Each connector is inserted through the loop formed by a corresponding one of the ribbons. A method of hanging a curtain is also disclosed.

### CROSS-REFERENCE TO RELATED APPLICATION

The present case claims priority to U.S. Provisional Patent Application No. 61/381,308 filed on 9 Sep. 2010, the entire contents of which are hereby incorporated by reference.

### TECHNICAL FIELD

The technical field relates generally to curtains and to methods of hanging curtains.

### BACKGROUND

Curtains are commonly used in homes and in many other places. They are generally provided to cover all or part of a window in a decorative manner. Most curtains can be opened or closed as required. To do so, a person can pull or push the curtain by hand so as to move at least a portion thereof along a pole or a track. Alternatively, a track mechanism can be operated to open or close the curtain, involving for instance a cord to be pulled by the person.

Some curtains are made of a material that can be more difficult to manipulate than others using conventional arrangements. An example is a semi-rigid panel, such as a panel including vertical bamboo strips connected to one another. Other kinds of materials can be similarly difficult to manipulate. One common way of hanging such curtains is to use spaced-apart eyelets provided at their respective upper edge. These eyelets are then inserted over a corresponding horizontal pole. Such arrangement, however, have limitations. For instance, it does not allow the panel to be flat when fully extended and the eyelets tend to remain stuck in certain positions, thereby sometimes making the panel difficult to manipulate. Other arrangements involve the use of a track mechanism. Such arrangements, however, increase the cost and complexity of the installation. Room for improvements thus always exists in this area.

### SUMMARY

In one aspect, there is provided a curtain hung under a horizontal pole. The curtain includes a foldable panel having an upper edge and two opposite side edges. The foldable panel is reversibly moveable between an extended flat position and a fully folded position upon moving the opposite side edges relative to one another. The panel forms a plurality of juxtaposed sections separated by vertical pleats when the panel is folded. The curtain also includes a plurality of spaced-apart ribbons. Each ribbon has opposite ends connected to the upper edge of the panel and forms a loop. The ribbons extend above the upper edge of the panel when the curtain is hung under the horizontal pole. The curtain further includes a plurality of rigid connectors to be loosely inserted over the horizontal pole. Each connector is inserted through the loop formed by a corresponding one of the ribbons.

In another aspect, there is provided a method of hanging a curtain. The method includes: attaching a plurality of spaced-apart ribbons to an upper edge of a foldable panel, each ribbon forming a loop; attaching a plurality of rigid connectors to the loops formed by the ribbons; inserting the connectors over an horizontal pole so that the panel be suspended by gravity underneath the pole; and once the panel is suspended, moving the panel freely between an extended flat position and a fully folded position upon moving opposite side edges of the panel relative to one another, the panel forming a plurality of juxtaposed sections separated by vertical pleats when the panel is folded.

Further details on these aspects as well as other aspects of the proposed concept will be apparent from the following detailed description and the appended figures.

### BRIEF DESCRIPTION OF THE FIGURES

FIG. 1 is a front isometric view illustrating an example of a curtain incorporating the proposed concept;

FIG. 2 is a front elevational view of the curtain shown in FIG. 1;

FIG. 3 is a left side view of the curtain shown in FIG. 1; and

FIG. 4 is a view similar to FIG. 1, showing the curtain panel in a partially folded position.

### DETAILED DESCRIPTION

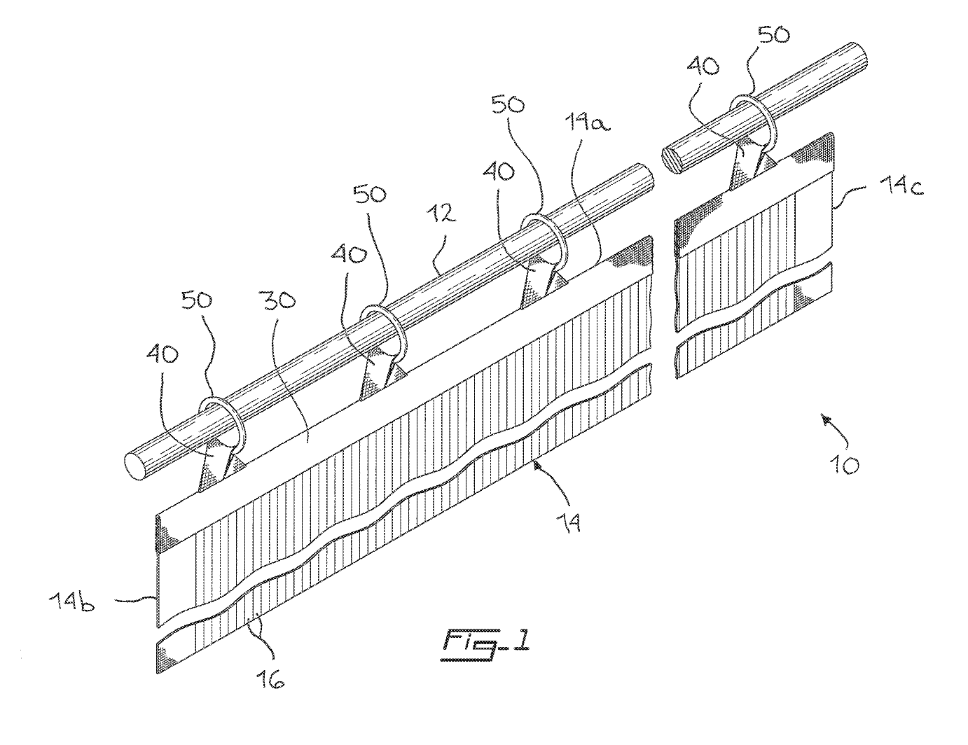

FIG. 1 is a front view illustrating an example of a curtain 10 incorporating the proposed concept. The curtain 10 is shown in a fully extended position in FIG. 1. This curtain 10 is designed to be hung under a horizontal pole, such as the pole 12 shown in the figures. The exact length and height of the curtain 10 can vary greatly from one installation to another. For this reason, the curtain 10 is illustrated has having an indefinite length and height. The illustrated pole 12 has a substantially circular cross section and a continuous unobstructed surface.

The curtain 10 includes a foldable panel 14. The panel 14 has an upper edge 14a and two opposite side edges 14b, 14c. The panel 14 can be made of a soft or a semi-rigid material, depending on the requirements. For instance, it can be made of one or more pieces of fabric. An example of a semi-rigid material is one including a plurality of vertically-extending and juxtaposed bamboo strips 16 connected to one another, as illustrated in FIG. 1. Other materials are possible as well.

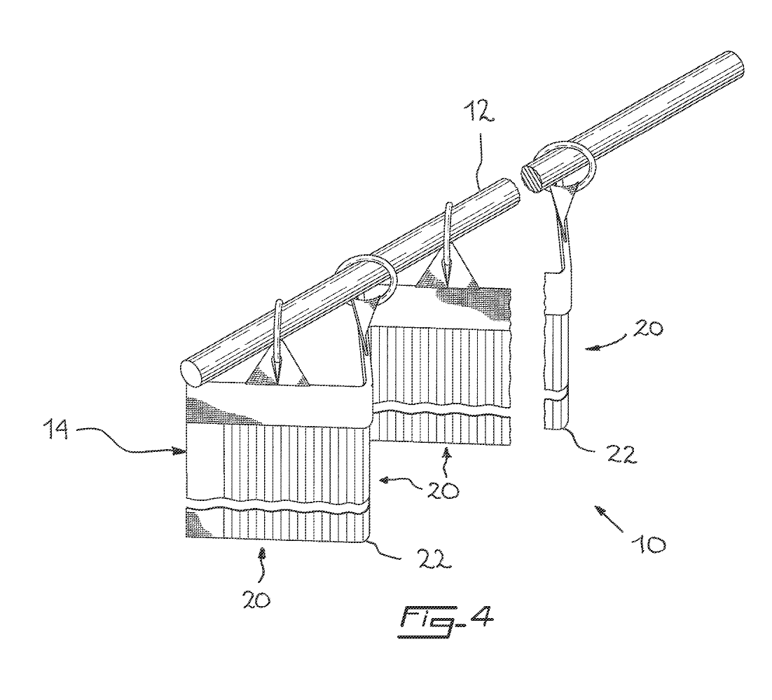

The panel 14 is reversibly moveable between an extended flat position, such as in FIG. 1, and a fully folded position upon moving the opposite side edges 14b, 14c relative to one another. The panel 14 is said to be in a partially folded position when set in-between the extended flat position and the fully folded position. When folded, as shown in FIG. 4, the panel 14 forms a plurality of juxtaposed sections 20 separated by vertical pleats 22. FIG. 4 is a view similar to FIG. 1, showing the curtain panel 14 in a partially folded position.

In the illustrated example, the upper edge 14a of the panel 14 includes a tape 30 extending continuously between the opposite side edges 14b, 14c. Other arrangements and configurations are possible.

The curtain 10 includes a plurality of spaced-apart ribbons 40. Each ribbon 40 has opposite ends connected to the upper edge 14a of the panel 14 and form a loop. For instance, the ribbons 40 can be stitched to the upper edge 14a. The ribbons 40 extend above the upper edge 14 when the curtain 10 is hung under the horizontal pole 12. Each ribbon 40 can be made a woven material but other material are also possible as well.

In the illustrated example, the opposite ends of each ribbon 40 are connected at a different position along the upper edge 14a and the ends of the ribbons 40 extend substantially parallel to the upper edge 14a. This way, each ribbon 40 forms an inverted “V” when viewed from the front or the rear, as shown for instance in FIG. 2. FIG. 2 is a front elevational view of the curtain 10 shown in FIG. 1.

There is at least one ribbon 40 for each section 20 of the panel 14. The corresponding ribbon 40 is substantially centered with reference to an upper end of the section 20. Other configurations and arrangements are possible.

The curtain 10 includes a plurality of rigid connectors 50 to be loosely inserted over the horizontal pole 12. Each connector 50 is inserted through the loop formed by a corresponding one of the ribbons 40. In the illustrated example, each connector 50 includes a ring shaped main portion. The ring-shaped main portions of the connectors 50 are inserted through the loops formed by the ribbons 40.

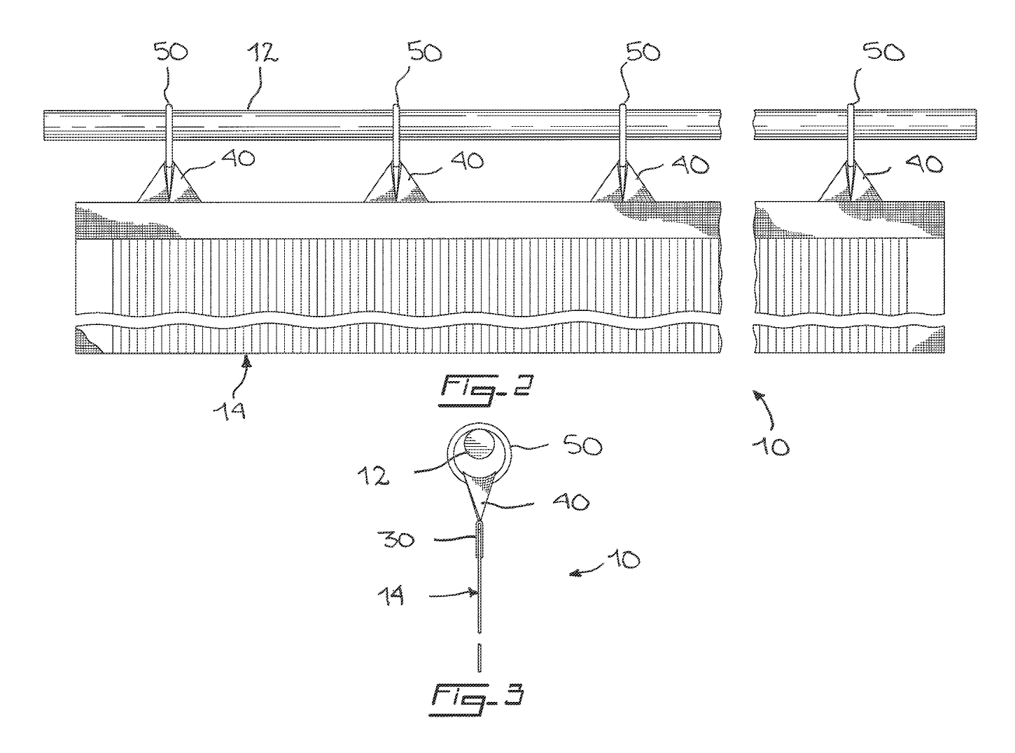

FIG. 3 is a left side view of the curtain 10 shown in FIG. 1.

The present detailed description and the appended figures are meant to be exemplary only, and a skilled person will recognize that many changes can be made while still remaining within the proposed concept. For instance, the materials that can be used are necessarily limited to these specifically mentioned in the present description. More than one ribbon can be used for each section of the panel and more than one rigid connector can be used with each loop. Stitching is only one possible way of connecting the ribbons to the upper edge of the panel. The ends of one or more ribbons can be overlapped, at least in part. Different kinds of ribbons can be used on a same panel. The rigid connectors can have non-circular shapes and need not to be all identical. The pole for use with the curtain is not necessarily rectilinear, other shapes and configuration being possible. Still, many other variants of the proposed concept will be apparent to a skilled person, in light of a review of the present disclosure.

What is claimed is:

1. A curtain to be hung under a horizontal pole, the curtain including:
a foldable panel having an upper edge and two opposite side edges, the foldable panel being reversibly moveable between an extended flat position and a fully folded position upon moving the opposite side edges relative to one another, the panel forming a plurality of juxtaposed sections separated by vertical pleats when the panel is folded;
a plurality of spaced-apart ribbons, each ribbon having opposite ends connected to the upper edge of the panel and forming a loop, the ribbons extending above the upper edge of the panel when the curtain is hung under the horizontal pole; and
a plurality of rigid connectors to be loosely inserted over the horizontal pole, each connector being inserted through the loop formed by a corresponding one of the ribbons.

2. The curtain as defined in claim 1, wherein each ribbon is made a woven material.

3. The curtain as defined in claim 1, wherein each ribbon is stitched to the upper edge of the panel.

4. The curtain as defined in claim 1, wherein the opposite ends of each ribbon are connected at a different position along the upper edge of the panel.

5. The curtain as defined in claim 1, wherein the ends of the ribbons extend substantially parallel to the upper edge of the panel.

6. The curtain as defined in claim 1, wherein there is at least one ribbon for each section of the panel.

7. The curtain as defined in claim 6, wherein at each section of the panel, the corresponding ribbon is substantially centered with reference to an upper end of the section.

8. The curtain as defined in claim 1, wherein the upper edge of the panel includes a tape extending continuously between the opposite side edges.

9. The curtain as defined in claim 1, wherein the connectors each include a ring-shaped main portion.

10. The curtain as defined in claim 9, wherein the ring-shaped main portions of the connectors are inserted through the loops formed by the ribbons.

11. The curtain as defined in claim 1, wherein the panel is made of a semi-rigid material.

12. The curtain as defined in claim 11, wherein the semi-rigid material includes plurality of vertically-extending and juxtaposed bamboo strips connected to one another.

13. The curtain as defined in claim 1, wherein the panel is made of one or more pieces of fabric.

14. A method of hanging a curtain, the method including:
attaching a plurality of spaced-apart ribbons to an upper edge of a foldable panel, each ribbon forming a loop;
attaching a plurality of rigid connectors to the loops formed by the ribbons;
inserting the connectors over an horizontal pole so that the panel be suspended by gravity underneath the pole; and
once the panel is suspended, moving the panel freely between an extended flat position and a fully folded position upon moving opposite side edges of the panel relative to one another, the panel forming a plurality of juxtaposed sections separated by vertical pleats when the panel is folded.

15. The method as defined in claim 14, wherein attaching the ribbons includes stitching the ribbons to the upper edge of the panel.

16. The method as defined in claim 14, further including:
using a plurality of vertically-extending and juxtaposed bamboo strips connected to one another as the foldable panel.

17. The method as defined in claim 14, wherein attaching the plurality of rigid connectors is carried out while attaching the plurality of spaced-apart ribbons to the upper edge of the foldable panel.

18. The method as defined in claim 14, wherein attaching the plurality of spaced-apart ribbons to the upper edge of the foldable panel includes giving an inverted “V” shape to at least some of the ribbons.

19. The method as defined in claim 14, wherein attaching the plurality of spaced-apart ribbons to the upper edge of the foldable panel includes centering each ribbon with reference to a corresponding one of the juxtaposed sections.

20. The method as defined in claim 14, further including:
using a plurality of ring-shaped connectors as the rigid connectors.
